(19) United States
(12) Patent Application Publication
(10) Pub. No.: US 2017/0353219 A1
(43) Pub. Date: Dec. 7, 2017

(54) SMALL CELL DISTRIBUTED PRECODING

(71) Applicants: ZTE Wistron Telecom AB, Kista Science Tower (SE); University of Bremen, Bremen (DE)

(72) Inventors: Armin DEKORSY, Bremen (DE); Henning PAUL, Bremen (DE); Dirk WUBBEN, Bremen (DE); Guang XU, Bremen (DE); Aijun CAO, Kista (SE); Thorsten SCHIER, Kista (SE); Yonghong GAO, Kista (SE); Jan JOHANSSON, Kista (SE); Patrick SVEDMAN, Kista (SE)

(21) Appl. No.: 15/611,639

(22) Filed: Jun. 1, 2017

Related U.S. Application Data
(60) Provisional application No. 62/344,829, filed on Jun. 2, 2016.

(51) Int. Cl. H04B 7/0456; H04B 7/024

(52) U.S. Cl. CPC H04B 7/0456; H04B 7/024

(57) ABSTRACT

Systems and methods for small cell distributed precoding. In one embodiment, a method includes: receiving remote precoding information from a plurality of small cells; sending local precoding information to the plurality of small cells; and transmitting an output signal as part of a joint transmission with the plurality of small cells in response to the receiving the remote precoding information, wherein the output signal is based on the remote precoding information and a user equipment data vector.

### RELATED APPLICATIONS

This application claims priority to U.S. Provisional Application No. 62/344,829 entitled “METHOD OF DISTRIBUTED COORDINATED PRECODING” filed on Jun. 2, 2016, the content of which is incorporated by reference herein in its entirety.

### TECHNICAL FIELD

The disclosure relates generally to wireless communications and, more particularly, to systems and methods for coordinated precoding in a distributed way in cellular telecommunication systems.

### BACKGROUND

Current mobile networks may be able to provide mobile users with data transmission service via almost ubiquitous radio access. Also, each individual user may demand higher and higher data rates. To meet user demand, multiple antennas may be utilized where radio signals are transmitted to a UE (User Equipment) from multiple antennas. These multiple antennas can be from the same or different geographical locations.

Also, network densification may be utilized to meet user demand. Network densification may be a technique to increase radio access by reducing handsets distances to base stations, resulting in less path-loss for transmitted radio signals. However, more interference may be present with network densification, especially in ultra dense networks (UDN) consisting of many small cells (SC), which may limit or offset the benefits from network densification. Due to the utilization of multiple antennas, it is possible for different cells to collaborate and cooperate with each other. Accordingly, multiple cell transmission and reception, which is commonly known as network Multi-Input-Multi-Output (MIMO), can be realized in a cooperative and/or distributed fashion in order to overcome network interference generated by network densification or UDN.

Distributed precoding applied in communications may include both uplink (UL) transmissions and downlink (DL) transmissions. Coordinated techniques for network MIMO systems may provide multi-user diversity gain and improve spectrum use efficiency in DL transmissions. However, a centralized node or a macro base station as the coordinator or scheduler is typically utilized for such coordinated transmissions. In contrast, distributed precoding may be adopted when a central node is not deployed. In distributed precoding, the UDN may be autonomously operated such that all cells cooperate with each other to achieve a coordinated transmission in a distributed way with locally determined or updated precoding parameters.

Additionally, centralized precoder optimization (i.e., centralized precoding), such as for joint transmissions, may not be computationally efficient, especially for large scale coordinate networks as the computational cost of joint processing significantly increases with the number of UEs and/or SCs. In contrast to centralized precoder optimization, distributed precoder optimization (i.e., distributed precoding) may perform precoder optimization in a distributed way where precoding can be devised at each small cell in a distributed manner between SCs and UEs. However, an undesirably large amount of information may be exchanged between the SCs and UEs (i.e., transmitters and receivers) when performing traditional distributed precoding.

Therefore, existing formats and/or techniques for distributed precoding are not entirely satisfactory.

### SUMMARY OF THE INVENTION

The exemplary embodiments disclosed herein are directed to solving the issues relating to one or more of the problems presented in the prior art, as well as providing additional features that will become readily apparent by reference to the following detailed description when taken in conjunction with the accompany drawings. In accordance with various embodiments, exemplary systems, methods, devices and computer program products are disclosed herein. It is understood, however, that these embodiments are presented by way of example and not limitation, and it will be apparent to those of ordinary skill in the art who read the present disclosure that various modifications to the disclosed embodiments can be made while remaining within the scope of the invention.

In one embodiment, a method includes: receiving remote precoding information from a plurality of small cells; sending local precoding information to the plurality of small cells; and transmitting an output signal as part of a joint transmission with the plurality of small cells in response to the receiving the remote precoding information, wherein the output signal is based on the remote precoding information and a user equipment data vector.

In a further embodiment, a system includes: a plurality of small cells, wherein each of the plurality of small cells is configured to: receive signal vectors from other small cells of the plurality of small cells, and produce an output signal in response to receiving the signal vectors, wherein: the output signal is part of a joint transmission from each of the plurality of small cells to a plurality of user equipment, and the output signal is based upon the signal vectors and a user equipment data vector.

In another embodiment, a system includes: a plurality of small cells, wherein each of the plurality of small cells is configured to: receive precoding matrices from other small cells of the plurality of small cells, and produce an output signal in response to receiving the precoding matrixes, wherein: the output signal is part of a joint transmission from each of the plurality of small cells to a plurality of user equipment, and the output signal is based upon the precoding matrices and a user equipment data vector.

### BRIEF DESCRIPTION OF THE DRAWINGS

Various exemplary embodiments of the invention are described in detail below with reference to the following Figures. The drawings are provided for purposes of illustration only and merely depict exemplary embodiments of the invention to facilitate the reader's understanding of the invention. Therefore, the drawings should not be considered limiting of the breadth, scope, or applicability of the invention. It should be noted that for clarity and ease of illustration these drawings are not necessarily drawn to scale.

FIG. 1 illustrates an exemplary distributed radio access network in which techniques disclosed herein may be implemented, in accordance with some embodiments.

FIG. 2 is an exemplary block diagram that illustrates how techniques disclosed herein may be implemented, in accordance with some embodiments.

### DETAILED DESCRIPTION OF EXEMPLARY EMBODIMENTS

Various exemplary embodiments of the invention are described below with reference to the accompanying figures to enable a person of ordinary skill in the art to make and use the invention. As would be apparent to those of ordinary skill in the art, after reading the present disclosure, various changes or modifications to the examples described herein can be made without departing from the scope of the invention. Thus, the present invention is not limited to the exemplary embodiments and applications described and illustrated herein. Additionally, the specific order or hierarchy of steps in the methods disclosed herein are merely exemplary approaches. Based upon design preferences, the specific order or hierarchy of steps of the disclosed methods or processes can be re-arranged while remaining within the scope of the present invention. Thus, those of ordinary skill in the art will understand that the methods and techniques disclosed herein present various steps or acts in a sample order, and the invention is not limited to the specific order or hierarchy presented unless expressly stated otherwise.

In addition, the present disclosure may repeat reference numerals and/or letters in the various examples. This repetition is for the purpose of simplicity and clarity and does not in itself dictate a relationship between the various embodiments and/or configurations discussed.

The present disclosure provides various embodiments of small cell distributed precoding with coordinated transmission between small cells (SCs). Advantageously, by performing small cell distributed precoding by coordinating among SCs (as opposed to coordinating between SCs and user equipment (UE)), the complexity of distributed precoding and the communication overhead (e.g., amount of communication or information) may be reduced, freeing up communication resources and processing power of these various devices for other tasks. In certain embodiments, small cell distributed precoding may be applied for downlink (DL) transmissions in ultra dense networks (UDN) (of a distributed radio access networks D-RAN, for example). As will be discussed further below, a UDN may refer to the collection of small cells in a D-RAN, while a D-RAN may refer collectively to the UDN, associated UEs, and interface (e.g., router) to a core network).

As introduced above, in a D-RAN, no central processing unit such as a base band unit (BBU), may be deployed. Instead, UE data may be processed among SCs within the network (i.e., without centralized processing). Therefore, a cooperative processing protocol is required when such SCs perform small cell distributed precoding in order to achieve the same or comparable performance achieved with centralized processing for precoding. In other words, in a UDN that performs small cell distributed precoding, the centralized processing functionality of a BBU in a centralized radio access network (C-RAN) is shifted to the constituent SCs of a D-RAN, wherein each SC executes small cell distributed precoding.

Accordingly, during small cell distributed precoding, different types of precoding information may be exchanged among the different small cells to coordinate precoding across the UDN of a D-RAN, for example. This precoding information may be utilized by SCs within a UDN to determine each local (i.e., individual) transmit signal at each SC that contributes to a joint transmission (JT), which may be a coordinated transmission from each of the active SCs to each of the active UEs in a D-RAN. For example, in certain embodiments, this precoding information may characterize Tx (transmit) signal vectors from each SC, and may be based upon the signals transmitted by the SCs to the UEs in a JT. In further embodiments, this precoding information may characterize local precoding matrices used by SCs locally for precoding (and used to determine the signals transmitted by the SCs to the UEs in a JT). In additional embodiments, this precoding information may characterize local Tx (transmit) power, which may be utilized to dynamically calculate an automatic gain control factor (in contrast with other embodiments where the automatic gain control factor is a constant scalar and not dynamically determined). Additionally, in certain embodiments, the precoding information may be exchanged or calculated iteratively (e.g., be based upon previous exchanges among SCs or calculations at SCs) to coordinate precoding among SCs. These iterations may be dependent on factors such as whether the input data vector for transmission to a UE has changed or if the communication channel that the signals are to propagate through has changed. Features of these embodiments, as well as other embodiments, will be discussed in greater detail below.

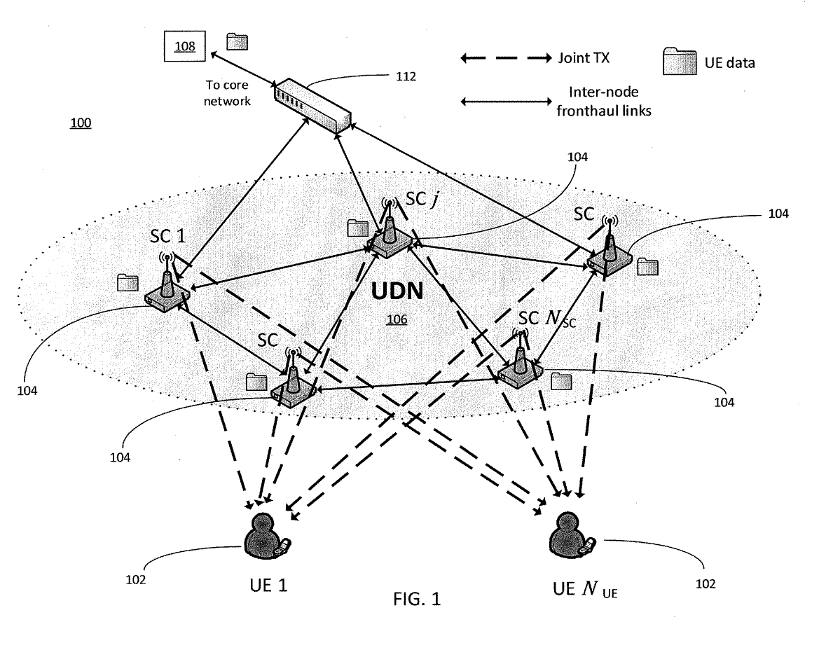

FIG. 1 illustrates an exemplary distributed radio access network 100 in which techniques for small cell distributed precoding disclosed herein may be implemented, in accordance with some embodiments. As illustrated in FIG. 1, in an exemplary D-RAN 100, an arbitrary number (N_{UE}) of UEs 102 are served by an arbitrary number (N_{SC}) of SCs 104 in a UDN 106. Also, the designation of “j” next to an SC or UE may refer to an arbitrary one of the SCs or UEs. UE data may be delivered from a core network 108 (that provides a UE data vector inclusive of data for transmission to UEs of a D-RAN) to each SC 104 via a router 112, as will be discussed in further detail below. Although each SC 104 may transmit its own transmit signals (also denoted as “Tx” or a “Tx signal”) to the UEs 102 independently, strong interference may be introduced by the individual transmissions when the UEs 102 transmit simultaneously, as mentioned above. To avoid such interference, in some embodiments, a joint transmission (JT) may be performed. This JT may be performed by all SCs 104 in a distributed way with information sharing through the SC to SC links. Accordingly, each SC 104 may cooperate with other SCs 104 to develop its local precoder (i.e., to determine its own local precoding). Furthermore, each SC 104 and UE 102 may include a local processor, transceiver, and memory that may be utilized for small cell distributed precoding.

In certain embodiments, the UEs 102 may not be involved in the development of the distributed precoder. Advantageously, by not requiring UE involvement for small cell distributed precoding, the UE's processing and communication resources that would have otherwise been utilized for precoding may now be freed up, reducing the complexity and the communication overhead of the D-RAN 100.

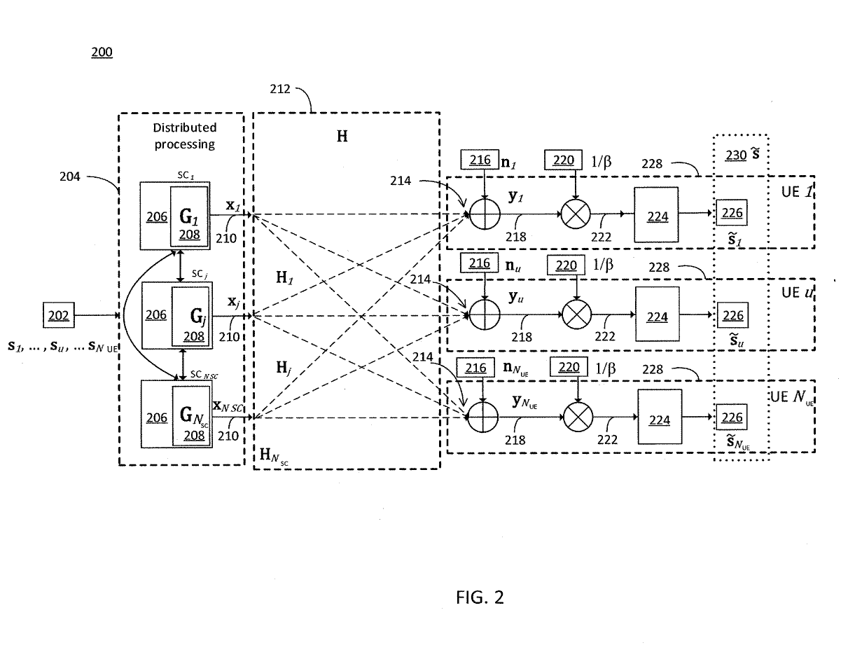

FIG. 2 is an exemplary block diagram 200 that illustrates how techniques disclosed herein may be implemented, in accordance with some embodiments. As will be indicated below, the discussion of various blocks in the block diagram 200 may also refer to various actors illustrated in the distributed radio access network 100 of FIG. 1.

Referring to FIG. 2, the block diagram 200 illustrates how UE data vectors 202 (which may be denoted as s₁, . . . , sᵤ, . . . , s_{N UE}, where an arbitrary UE of an arbitrary number of UEs may be designated with subscript “u”) may be inputs for a UDN 204 of SCs 206 performing small cell distributed precoding. The UDN 204 of FIG. 2 may be comprised of an arbitrary number of SCs 206 (which also may be noted with SC₁, . . . , SCⱼ, . . . SC_{N SC}, where an arbitrary SC of an arbitrary number of SCs is designated with a subscript “j”). The UE data vectors 202 may be data signals for transmission to the UEs 228, as will be discussed further below.

Referring to FIG. 1 and FIG. 2, the UE data vectors 202 (illustrated in FIG. 2) may be received from the core network 108 (illustrated in FIG. 1). Also, the UDN 204 (illustrated in FIG. 2) may also be represented by the UDN 106 (illustrated in FIG. 1), the SCs 206 (illustrated in FIG. 2) may also be represented by the SCs 104 (illustrated in FIG. 1), and the UEs 228 (illustrated in FIG. 2) may also be represented by the UEs 102 (illustrated in FIG. 1).

Returning to FIG. 2, small cell distributed precoding may utilize information exchanged between SCs 206 within the UDN 204 (without requiring input from UEs 228),in accordance with some embodiments. Also, each SC 206 of the UDN 204 may determine its own local precoding 208 in a distributed manner (which may be denoted as G₁, . . . , Gⱼ, . . . , G_{N SC}, where precoding at an arbitrary SC is denoted with subscript “j”), such as with a precoding matrix, as will be discussed below. This local precoding 208 (e.g., with local precoding matrixes) may be determined based on the respective UE data vectors 202 and information shared among each SC 206. Also, as will be discussed in further detail below, each SC 206 may produce a transmit (Tx) signal 210 (which also may be denoted as x₁, . . . , x_{J}, . . . , x_{N SC}, where an arbitrary transmit signal (from the arbitrary SC) is designated with subscript (j) based upon the UE data vectors 202 and precoding 208 with precoding information (e.g., a local precoding matrix).

Referring again to FIG. 1 and FIG. 2, the information exchanged between SCs 206 within the UDN 204 as illustrated with bidirectional arrow lines between the SCs 206 in FIG. 2 may be represented in FIG. 1 by information exchanged between SCs 104 as illustrated with the bidirectional arrow lines between the SCs 104.

Returning to FIG. 2, each transmit signal 210 may pass through (and be modified by) a channel system 212, which may be decomposed into individual channels (denoted as H₁, . . . , H_{J}, . . . , H_{N}, where an arbitrary individual channel (from the arbitrary transmit signal) is designated with subscript “j”). After passing through the channel system 212, the transmit signals 210 (that pass through the channel system 212) are received as received signals 214 at each UE 228. The channel system 212 may represent the environment or medium through which each transmit signal 210 passes through (e.g., air, or a wire). As noted above, each transmit signal 210 may be transmitted as a JT to the UEs 228 (represented in the block diagram by the branches of dotted line arrows that fork from the transmit signal 210 and pass through the channel system 212).

Referring to FIG. 1 and FIG. 2, the propagation of the received signals 214 across the channel system 212 to reach the UEs 228, as represented by the dotted arrow lines of the joint transmission across the channel system 212 to reach the UEs 228 illustrated in FIG. 2, may also be represented in FIG. 1 by the dotted arrow lines from the SCs 104 to the UEs 102 representing the joint transmission.

Returning to FIG. 2, each UE 228 may receive the received signals 214 from the JT. Stated another way, the UEs 228 are served using identical time-frequency resources to achieve a high spectral efficiency. Therefore, every UE 228 receives the superposition of all SCs Tx signals 210, each linearly distorted by an individual channel (e.g., H₁, . . . , H_{J}, . . . , H_{N}), resulting in the received signals 214 at each UE 228. The received signals 214 received at each UE 228 may be summed with a local variation signal 216 (such as local noise, which is undesirable but typically unavoidably produced locally at each UE 228) to produce a first UE signal 218 (denoted as y₁, . . . , yᵤ, . . . , y_{N UE}, where an arbitrary UE of an arbitrary number of UEs may be designated with subscript “u”, as noted above). The local variation signal 216 may be denoted as n₁, . . . nᵤ, . . . , n_{N UE} and with subscripts that match the subscripts (e.g., designations) of UEs 228 and UE data vectors 202 as noted above. Similarly, the first UE signal 218 may be denoted as y₁, . . . , yᵤ, . . . , y_{N UE}, and with subscripts that match the subscripts (e.g., designations) of UEs 228 and UE data vectors 202 as noted above. Also, an arbitrary one of the signals at a UE 228, such as an arbitrary local variation signal 216 and an arbitrary first UE signal 218, may be denoted with subscript “u”, as noted above. At each UE, the first UE signal 218 may be multiplied by the inverse of the automatic gain control factor β 220 (which may also be known as an automatic power factor) to produce a second UE signal 222. The second UE signal 222 may undergo further local processing by a local processing unit 224 (e.g., noise filtering, amplification, interference cancellation, and the like) to produce a local modified data vector 226 for each UE 228. Each of the local modified data vectors 226 across the UEs may constitute a modified UE data signal 230 (denoted as \tilde{s}, or individually as \tilde{s}₁, . . . , \tilde{s}ᵤ, . . . , \tilde{s}_{UEN} to mirror the original UE data vector 202 notation of s₁, . . . , sᵤ, . . . , s_{N}, as introduced above).

In certain embodiments, processing of signals received at the UEs 228 in the illustrated D-RAN block diagram 200 executing small cell distributed precoding may be the same as the processing of signals by UEs in a C-RAN. Accordingly, the discussion herein of signal processing at the UEs 228 (such as illustrated in FIG. 2) may be simplified for a better understanding of the concepts of the present disclosure. For example, although particular operations (e.g., blocks) of the UEs 228 are illustrated in FIG. 2, certain operations may be omitted, additional operations may be added, and some operations may only be briefly described herein.

The following discussion includes various embodiments of techniques for small cell distributed precoding that may be implemented by systems and methods represented by FIG. 1 and FIG. 2, provided by way of example below.

As introduced above, the UE data vector s=[s₁^{T}, . . . sᵤ^{T},. . . s_{NUE}^{T}]^{T} ∈ [symbol] ^{N}^{_{R}}^{N}^{_{UE}}^{×1} may be assumed to be available at each SC and the signal power of sᵤ may also be σₛ²=1. The local precoding matrix Gⱼ ∈ [symbol] ^{N}^{_{T}}^{×N}^{_{R}}^{N}^{_{UE}} and/or its local Tx signal xⱼ ∈ [symbol] ^{N}^{_{T}}^{×1} of SC j, j=1, . . . , N_{SC}, may be developed in a distributed way in accordance with certain embodiments, as will be discussed below, wherein [symbol] is the symbol alphabet (e.g. QAM), [symbol] is the set of complex numbers, NT refers to the number of transmit antennas at each SC, and NR refers to the number of receive antennas at each UE. Also, as discussed above, in some embodiments, the channel system and the processing at the receivers (e.g., UEs) remain the same as in a C-RAN.

In one exemplary embodiment, minimization of the square error problem may be used to derive the distributed solution:

$${min}_{G} {‖ s - \frac{1}{β} HGs ‖}^{2} = {min}_{x} {‖ s - \frac{1}{β} Hx ‖}^{2} = {min}_{{x}_{j}} {‖ s - {\sum }_{j}^{{N}_{SC}} \frac{1}{β} {H}_{j} {x}_{j} ‖}^{2} \\ s . t . E \{ {‖ Gs ‖}^{2} \} = P , \qquad ( 1 )$$

where x=[x₁^{T}, . . . , xⱼ^{T}, . . . , x_{N}_{_{SC}}^{T}]^{T} is the stacked vector of Tx signals from all SCs in a UDN, β is the automatic gain control factor, P is the total power constraint, s is the UE data vector, G is the local precoding matrix, N_{SC} is the total number of SCs, and H is the combined channel matrix for all SC-UE pairs. The solution for the considered problem will be given below, where both a first exemplary embodiment, for distributed calculation of local Tx signal xⱼ and a second exemplary embodiment, for distributed update of local precoding matrix Gⱼ, are discussed in detail. The below discussions of each of these (and other) exemplary embodiments may begin with a discussion of the underlying principles before a discussion of the type and manner of precoding information exchange for a UDN in accordance with each exemplary embodiment.

Although various embodiments may be described as first exemplary embodiments, second exemplary embodiments, and/or third exemplary embodiments (as discussed further below), the designation of the first exemplary embodiments, second exemplary embodiments, third exemplary embodiments and/or other exemplary embodiments is non-limiting and utilized for clarity of discussion. Accordingly, numerous embodiments may include combinations of features described in the first exemplary embodiments, second exemplary embodiments, third exemplary embodiments, and/or other exemplary embodiments as desired for various applications. For example, certain embodiments may include features in accordance with the first exemplary embodiments at certain times and in accordance with the second exemplary embodiments at other times.

As will be discussed further below, first exemplary embodiments may describe the distributed calculation of Tx signals of local SCs. Also, second exemplary embodiments may describe distributed calculation of local precoding matrices. Both the first exemplary embodiments and the second exemplary embodiments may be realized by the Jacobi method and its modified approach, the two-step Jacobi method (TSJ). In numerical linear algebra, the Jacobi method and the two-step Jacobi method (TSJ) may be processes for determining solutions of a diagonally dominant system of linear equations. Each diagonal element is solved for, and an approximate value is plugged in (i.e., inputted). The processes are then iterated until they converge.

With reference to the first exemplary embodiments, the Tx signal x=Gs may be solved by taking the first derivative of the objective function (1) with respect to the Tx signal x to obtain the linear system (2):

$$\underbrace{( {H}^{H} H )}_{A} x = \underbrace{β {H}^{H} s}_{b} . \qquad ( 2 )$$

where H^{H} is the Hermitian (i.e., the conjugate complex transpose) of H, A is defined as H^{H}H, b is defined as βH^{H}s, β is the automatic gain control factor, and s is the UE data vector. For this derivation, the automatic gain control factor β is firstly assumed to be a constant scalar (in contrast with other embodiments with a dynamic obtainment of β as will be discussed below). The matrix A=H^{H}H may be decomposed into diagonal block matrix D and off-diagonal block matrix R leading to (D+R)x=b. This system can be solved in an iterative way according to the Jacobi method as:

x^{k+1}=−D⁻¹Rx^{k}+D⁻¹b, (3)

where k is the iteration number, where D represents a matrix containing the diagonal blocks of A, and R represents a matrix containing the remaining elements. Furthermore, as represented in the below formula:

$$( \begin{matrix}{H}_{1}^{H} {H}_{1} {x}_{1}^{k + 1} \\ ⋮ \\ {H}_{{N}_{SC}}^{H} {H}_{{N}_{SC}} {x}_{{N}_{SC}}^{k + 1}\end{matrix} ) = ( \begin{matrix}β {H}_{1}^{H} s - {\sum }_{i = 2}^{{N}_{SC}} {H}_{1}^{H} {H}_{i} {x}_{i}^{k} \\ ⋮ \\ β {H}_{{N}_{SC}}^{H} s - {\sum }_{i = 1}^{{N}_{SC - 1}} {H}_{{N}_{SC}}^{H} {H}_{i} {x}_{i}^{k}\end{matrix} ) , \qquad ( 4 )$$

each row of the above system is independent from other rows. Accordingly, the update of Tx signal vector xⱼ^{k+1} at SC j may be given by:

$${x}_{j}^{k + 1} = {( {H}_{j}^{H} {H}_{j} )}^{- 1} ( β {H}_{j}^{H} s - {\sum }_{i \neq j}^{{N}_{SC}} {H}_{j}^{H} {H}_{i} {x}_{i}^{k} ) , j = 1 , 2 , … , {N}_{SC} . \qquad ( 5 )$$

Note that each Tx signal xⱼ^{k+1} may be calculated locally at SC j with the information Hᵢxᵢ^{k} from other SCs i. With reference to the Jacobi method, the solution to (4) may be obtained when the spectral radius, i.e., ρ(D⁻¹R)<1. However, in the above described system, such conditions may be difficult to fulfill, as the diagonal block matrix D may not be dominant compared with the matrix R, i.e., ρ(D⁻¹R)>1. Accordingly, in one embodiment, a variant of the first exemplary embodiments may be adopted for solving the linear system in a distributed way, as discussed in further detail below.

In accordance with some embodiments, a parameter γ is introduced to enhance the diagonal dominance of A leading to a new approach, a Two-Step Jacobi (TSJ) approach with the modified linear system (γD+R)x=b+(γ−1)Dx from (5), such that the Tx signal x can be calculated in an iterative way with a given formula at iteration m as follows:

x^{m}=(γD+R)⁻¹b+(γ−1)(γD+R)⁻¹Dx^{m-1}, (6)

where x^{m} converges to a central solution if the spectral radius ρ((γ−1)(γD+R)⁻¹D)<1, which can be satisfied by selecting a proper γ, where γ is a tuning parameter for optimization of the convergence speed. To avoid a large matrix inversion and enable the distributed calculation of x^{m} among SCs, in some embodiments, additional iterative processing is used to solve the linear system as follows:

$${\underbrace{( γ D + R )} }_{{A}^{–}} {x}^{m} = {\underbrace{b + ( γ - 1 ) {Dx}^{m - 1}}}_{{b}^{–}} . \qquad ( 7 )$$

For each iteration m, the vector b is fixed and it is determined by the vector x^{m-1} from the last iteration m−1. In order to solve x^{m} in a distributed way, the Jacobi method can again be used for the distributed implementation (note that ρ((γD)⁻¹R)<1 is fulfilled), thus another inner iterative operation with the maximum number K may be performed. For the Tx signal xⱼ^{k+mK} at SC j in the outer loop m and inner loop k, an updated representation is given as:

$${x}_{j}^{k + mK} = {γ ( {H}_{j}^{H} {H}_{j} )}^{- 1} ( β {H}_{j}^{H} s - ( γ - 1 ) {H}_{j}^{H} {H}_{j} {x}_{j}^{( m - 1 ) K} - {\sum }_{i \neq j}^{{N}_{SC}} {H}_{j}^{H} {H}_{i} {x}_{i}^{k - 1 + mK} ) , \qquad ( 8 )$$

where N_{It}=k+mK denotes the current number of iterations. It can be noted that the iteration variables m and k are updated in the outer iteration (over m) and stays constant over the inner loop (over k). This reflects a flat indexing scheme that increases with every inner iteration (as opposed to using dual indices for inner and outer iteration). As (8) indicates, the update of local Tx signal xⱼ^{k+mK} per iteration uses the local information Hⱼ, xⱼ^{(m-1)K} as well as the weighted Tx signals vector Hᵢxᵢ^{k-1+mK} from other SCs i in previous iteration k−1+mK. Accordingly, in each iteration, all SCs (in a UDN) exchange their local calculated Tx signal vectors Hᵢxᵢ, which leads to communication overhead O over SC-SC links. If we assume that each SC broadcasts the information once, and the corresponding messages Hᵢxᵢ∈ [symbol] ^{N}^{_{R}}^{N}^{_{UE}}^{×1} can be received by other SCs, then the total communication overhead produced per iteration within the network can be counted as O₁=N_{SC}·N_{R}N_{UE} (and may be a complex number).

In the second exemplary embodiments, the distributed local precoding matrix of each SC is firstly calculated. This may contrast with the first exemplary embodiments where the Tx signal vectors of all SCs are directly calculated in a distributed way. In accordance with the second exemplary embodiments, for each SC j, the local precoder Gⱼ may be updated in an iterative way. Stated another way, the Tx signal xⱼ may be precoded as xⱼ=Gⱼs. Accordingly, the linear system (2) can be rewritten as:

(H^{H}H)G=βH^{H}. (9)

As introduced above, the TSJ approach can be applied for the distributed calculation of the precoding matrix. Accordingly, by taking xⱼ=Gⱼs into (8), a two-loop iterative update of local precoding matrix Gⱼ at SC j may be obtained:

$${G}_{j}^{k + mK} = {γ ( {H}_{j}^{H} {H}_{j} )}^{- 1} ( β {H}_{j}^{H} - ( γ - 1 ) {H}_{j}^{H} {H}_{j} {G}_{j}^{( m - 1 ) K} - {\sum }_{i \neq j}^{{N}_{SC}} {H}_{j}^{H} {H}_{i} {G}_{i}^{k - 1 + mK} ) , \qquad ( 10 )$$

where k indicates the inner iteration number and K is the maximum number of inner iterations. When k=K, then the number of outer iteration m will increase and correspondingly k is reset to 1. Here, N_{It}=k+mK denotes the current number of iterations. For the distributed calculation (10) in iteration k+mK , each SC j uses the matrices HᵢGᵢ^{k-1+mK} of other SCs i≠j from a previous iteration to update its local precoding matrix Gⱼ^{k+mK}.

In contrast to the first exemplary embodiments discussed above, in the second exemplary embodiments the matrices HᵢGᵢ∈ [symbol] ^{N}^{_{R}}^{N}^{_{UE}}^{×N}^{_{R}}^{N}^{_{UE}} may be exchanged among N_{SC} SCs. Accordingly, a relatively large amount of communication overhead per iteration is produced in the second exemplary embodiment (i.e., O₂=N_{SC}·(N_{R}N_{UE})² (which may be represented as an integer number)) is exchanged per iteration.

As introduced above, the communication overhead per iteration of the second exemplary embodiments may be much greater than the communication overhead per iteration of the first exemplary embodiments (e.g., which may be due to the exchanged matrices of the second exemplary embodiments typically using more communication overhead than the exchanged Tx signal vectors of the first exemplary embodiments). However, the Tx signals in the first exemplary embodiments are calculated iteratively for each new input data vector s regardless of the channel condition. In contrast, the precoding matrix in the second exemplary embodiments may be re-calculated when the channel is changed.

Accordingly, for a long stable channel model (e.g., where the channel system 212 and/or the UDN 204 and/or the UEs 228 of FIG. 2 is stable and unchanging), the second exemplary embodiments may, advantageously, save more (or have less) communication overhead than the first exemplary embodiments. However, for a rapidly changing channel (e.g., where the channel system 212 and/or the UDN 204 and/or the UEs 228 of FIG. 2 is not stable), the first exemplary embodiment approach may, advantageously, save more communication overhead than the second exemplary embodiments.

As discussed above, for the first exemplary embodiments and the second exemplary embodiments, the automatic gain control factor β is may be assumed to be a constant scalar (e.g., a constant parameter). However, in third exemplary embodiments, a distributed (e.g., dynamic) determination of β may be performed.

In certain embodiments, β can be determined independently by the non-normalized precoding matrix. Accordingly, in small cell distributed precoding, taking the first exemplary embodiments as an example, the non-normalized Tx signal x̅ⱼ of SCj may be updated following the same principle of the TSJ approach (8):

$${\overline{x}}_{j}^{k + mK} = {γ ( {H}_{j}^{H} {H}_{j} )}^{- 1} ( {H}_{j}^{H} s - ( γ - 1 ) {H}_{j}^{H} {H}_{j} {\overline{x}}_{j}^{( m - 1 ) K} - {\sum }_{i \neq j}^{{N}_{SC}} {H}_{j}^{H} {H}_{i} {\overline{x}}_{i}^{k - 1 + mK} ) , \qquad ( 11 )$$

Then, β can be determined by the non-normalized Tx signals x̅ⱼ according to the below:

$${β}_{ZF} = \sqrt{\frac{P}{tr ( {\overline{G}}_{ZF} {\overline{G}}_{ZF}^{H} )}} , \qquad ( 12 )$$

where:

G̅_{ZF}=H⁺=(H^{H}H)⁻¹H^{H}=H^{H}(HH^{H})⁻¹ (13)

and where ZF refers to the zero forcing solution, β_{ZF} represents the automatic gain control factor (obtained using zero forcing), G̅_{ZF} represents the central precoding matrix (obtained using zero forcing), H+ represents the Moore-Penrose pseudo inverse, and G̅_{ZF}^{H} represents the Hermitean of G̅_{ZF}. Accordingly, each SC j calculates its local Tx power tr(x̅ⱼx̅ⱼ^{H}) after N_{It} iterations (e.g., the number of iterations applied in total, after termination of the iterative process), and shares the scalar value with other SCs. This sharing may introduce communication overhead, but this communication overhead may be negligible. Once all scalars tr(x̅ⱼx̅ⱼ^{H}) are exchanged over the network (e.g., the UDN 204 of FIG. 2), each SC can calculate the automatic gain control factor β locally with the collected information:

$$β = \sqrt{\frac{P}{{\sum }_{j = 1}^{{N}_{SC}} tr ( {\overline{x}}_{j} {\overline{x}}_{j}^{H} )}} . \qquad ( 14 )$$

Once β is obtained, then, each SC j can normalize the Tx signal x̅ⱼ by the factor β in order to fulfill the total power constraint P, where

xⱼ=βx̅ⱼ (15)

While various embodiments of the invention have been described above, it should be understood that they have been presented by way of example only, and not of limitation. Likewise, the various diagrams may depict an example architectural or other configuration for the invention, which is done to aid in understanding the features and functionality that can be included in the invention. The present invention is not restricted to the illustrated example architectures or configurations, but can be implemented using a variety of alternative architectures and configurations. Additionally, although the invention is described above in terms of various exemplary embodiments and implementations, it should be understood that the various features and functionality described in one or more of the individual embodiments are not limited in their applicability to the particular embodiment with which they are described, but instead can be applied, alone or in some combination, to one or more of the other embodiments of the invention, whether or not such embodiments are described and whether or not such features are presented as being a part of a described embodiment. Thus the breadth and scope of the present invention should not be limited by any of the above-described exemplary embodiments.

One or more of the functions described in this document may be performed by one or more appropriately configured units. The term “unit” as used herein, refers to software that is stored on computer-readable media and executed by one or more processors, firmware, hardware, and any combination of these elements for performing the associated functions described herein. Additionally, for purpose of discussion, the various units may be discrete units; however, as would be apparent to one of ordinary skill in the art, two or more units may be combined to form a single unit that performs the associated functions according embodiments of the invention.

Additionally, one or more of the functions described in this document may be performed by means of computer program code that is stored in a “computer program product,” “computer-readable medium,” and the like, which is used herein to generally refer to media such as, memory storage devices, or storage unit. These, and other forms of computer-readable media, may be involved in storing one or more instructions for use by processor to cause the processor to perform specified operations. Such instructions, generally referred to as “computer program code” (which may be grouped in the form of computer programs or other groupings), which when executed, enable the computing system to perform the desired operations.

It will be appreciated that, for clarity purposes, the above description has described embodiments of the invention which can be implemented with one or more functional units and/or processors. However, it will be apparent that any suitable distribution of functionality between different functional units, processors or domains may be used without detracting from the invention. For example, functionality illustrated to be performed by separate units, processors or controllers may be performed by the same unit, processor or controller. Hence, references to specific functional units are only to be seen as references to suitable means for providing the described functionality, rather than indicative of a strict logical or physical structure or organization.

It is also understood that any reference to an element herein using a designation such as “first,” “second,” and so forth does not generally limit the quantity or order of those elements. Rather, these designations can be used herein as a convenient means of distinguishing between two or more elements or instances of an element. Thus, a reference to first and second elements does not mean that only two elements can be employed, or that the first element must precede the second element in some manner.

Additionally, a person having ordinary skill in the art would understand that information and signals can be represented using any of a variety of different technologies and techniques. For example, data, instructions, commands, information, signals, bits and symbols, for example, which may be referenced in the above description can be represented by voltages, currents, electromagnetic waves, magnetic fields or particles, optical fields or particles, or any combination thereof.

A person of ordinary skill in the art would further appreciate that any of the various illustrative logical blocks, modules, processors, means, circuits, methods and functions described in connection with the aspects disclosed herein can be implemented by electronic hardware (e.g., a digital implementation, an analog implementation, or a combination of the two), firmware, various forms of program or design code incorporating instructions (which can be referred to herein, for convenience, as “software” or a “software module), or any combination of these techniques.

To clearly illustrate this interchangeability of hardware, firmware and software, various illustrative components, blocks, modules, circuits, and steps have been described above generally in terms of their functionality. Whether such functionality is implemented as hardware, firmware or software, or a combination of these techniques, depends upon the particular application and design constraints imposed on the overall system. Skilled artisans can implement the described functionality in various ways for each particular application, but such implementation decisions do not cause a departure from the scope of the present disclosure. In accordance with various embodiments, a processor, device, component, circuit, structure, machine, module, etc. can be configured to perform one or more of the functions described herein. The term “configured to” or “configured for” as used herein with respect to a specified operation or function refers to a processor, device, component, circuit, structure, machine, module, etc. that is physically constructed, programmed and/or arranged to perform the specified operation or function.

What is claimed is:

1. A method, comprising:
receiving remote precoding information from a plurality of small cells;
sending local precoding information to the plurality of small cells; and
transmitting an output signal as part of a joint transmission with the plurality of small cells in response to the receiving the remote precoding information, wherein the output signal is based on the remote precoding information and a user equipment data vector.

2. The method of claim 1, wherein the remote precoding information comprises a remote signal vector from a remote small cell of the plurality of small cells, the remote signal vector based on a remote output signal transmitted from the remote small cell.

3. The method of claim 1, wherein:
the receiving the remote precoding information is performed over a plurality of iterations
the transmitting the output signal is performed at each iteration of the plurality of iterations.

4. The method of claim 1, wherein the local precoding information comprises a signal vector based on a past output signal transmitted prior to the output signal.

5. The method of claim 1, wherein the remote precoding information comprises a precoding matrix from a remote small cell of the plurality of small cells, wherein the precoding matrix was used to determine a remote output signal transmitted from the remote small cell.

6. The method of claim 1, wherein the local precoding information comprises a precoding matrix used to determine a past output signal transmitted prior to the output signal.

7. The method of claim 1, wherein the output signal is based on the local precoding information.

8. The method of claim 1, wherein the remote precoding information comprises a scalar output signal transmit power.

9. The method of claim 8, comprising determining a local automatic gain control factor based on the scalar output signal transmit power.

10. The method of claim 1, comprising receiving the user equipment data vector from a core network via a router.

11. A system, comprising:
a plurality of small cells, wherein each of the plurality of small cells is configured to:
receive signal vectors from other small cells of the plurality of small cells, and
produce an output signal in response to receiving the signal vectors , wherein:
the output signal is part of a joint transmission from each of the plurality of small cells to a plurality of user equipment, and
the output signal is based upon the signal vectors and a user equipment data vector.

12. The system of claim 11, wherein the signal vectors are based on remote output signals transmitted from the other small cells.

13. The system of claim 12, wherein each of the plurality of small cells is configured to produce the output signal after the remote output signals are transmitted.

14. The system of claim 11, wherein each of the plurality of small cells is configured to receive the signal vectors from the other small cells over a plurality of iterations.

15. The system of claim 14, wherein each iteration of the plurality of iterations is produced in response to a new user equipment data vector received by the plurality of small cells.

16. The system of claim 11, wherein each of the plurality of small cells is configured to receive the user equipment data vector from a core network.

17. The system of claim 11, wherein each of the plurality of small cells is configured to send a local signal vector to the other small cells.

18. A system, comprising:
a plurality of small cells, wherein each of the plurality of small cells is configured to:
receive precoding matrices from other small cells of the plurality of small cells, and
produce an output signal in response to receiving the precoding matrixes, wherein:
the output signal is part of a joint transmission from each of the plurality of small cells to a plurality of user equipment, and
the output signal is based upon the precoding matrices and a user equipment data vector.

19. The system of claim 18, wherein the precoding matrices were used to determine remote output signals transmitted from the other small cells.

20. The system of claim 19, wherein each of the plurality of small cells is configured to produce the output signal after the remote output signals are transmitted.

21. The system of claim 18, wherein each of the plurality of small cells is configured to receive the precoding matrices from the other small cells over a plurality of iterations.

22. The system of claim 21, wherein each iteration of the plurality of iterations is produced in response to a change in a channel that the output signal traverses.

23. The system of claim 18, wherein the output signal is independent of input from the plurality of user equipment.

24. The system of claim 18, wherein each of the plurality of small cells is configured to send a local precoding matrix to the other small cells.
